(19) United States
(12) Patent Application Publication
(10) Pub. No.: US 2004/0128930 A1
(43) Pub. Date: Jul. 8, 2004

(54) Heat insulating wall structure

(75) Inventor: Katsunori Ohnishi, Tokyo (JP)

Correspondence Address: SUGHRUE MION, PLLC, 2100 Pennsylvania Avenue, N.W., Washington, DC, 20037-3213, US

(73) Assignee: SEKISUI CHEMICAL CO., LTD.

(21) Appl. No.: 10/740,899

(22) Filed: Dec. 22, 2003

(30) Foreign Application Priority Data
Dec. 20, 2002 (JP) 2002-370645

(51) Int. Cl. E06B 3/54; E04B 9/00

(52) U.S. Cl. 52/474; 52/782.1

(57) ABSTRACT

The object of the invention is to provide heat insulating wall structure which is simple and in which the execution of works is easy, a cold (thermal) bridge is prevented by reducing heat conduction to a metal framework and the rust of the framework and internal dew condensation can be prevented. To achieve the object, a bearing plywood 2 is fastened to the outside of the metal frame 1, a furring strip 5 is fastened to the outside of the bearing plywood 2, an exterior finishing board 8 is fastened to the outside of the furring strip 5, and foamed heat insulating material 20 is inserted between the frame 1 and bearing plywood 2 or between the bearing plywood 2 and the furring strip 5. The foamed heat insulating material 20 is formed by mixing bearing members 30 made of rubber or plastic in a foamed body provided with a continuous foamed layer 21, highly foamed parts 22 arranged in plurality at least on one side of the continuous foamed layer and made of thermoplastic resin and lowly foamed thin parts 23 that covers the outer surface of the highly foamed parts together with the continuous foamed layer.

### FIELD OF THE INVENTION

The present invention relates to the heat insulating wall structure of a building and others, particularly relates to heat insulating wall structure for preventing internal dew condensation caused by a cold (thermal) bridge in a building provided with a metal framework and for preventing the rust of the framework.

### BACKGROUND OF THE INVENTION

Concerning conventional type heat insulating wall structure, heat insulating material arranged outside a metal frame is fastened to the metal frame by a screw for heat insulating material, an aeration furring strip arranged outside the heat insulating material is fastened to the metal frame by a screw for a furring strip, an exterior finishing board is attached to the outside, and the head of the screw for the furring strip is prevented from being exposed to a chill by burying the head of the screw for the furring strip in a concave portion of the aeration furring strip and filling the concave portion with urethane by a simple urethane spray (For example, refer to a patent document 1).

Concerning another heat insulating wall mounting structure, an aeration furring strip the cross section of which is convex is arranged outside a metal frame, a screw for the furring strip is pierced from a face on which the aeration furring strip is mounted and is fastened to the frame, a part having difference in a level of heat insulating material is overlapped with the face on which the aeration furring strip is mounted, the outside of the head of the screw for the furring strip is covered, and the heat insulating material is fastened to the aeration furring strip by a screw for the heat insulating material (For example, refer to a patent document 2).

Patent document 1: JP-A No. 140687/1998 (FIG. 1)

Patent document 2: JP-A No. 140688/1998 (FIG. 1)

Concerning the former heat insulating wall structure, as the concave portion is formed in the aeration furring strip, the head of the screw for the furring strip is buried in the concave portion and the concave portion is filled with urethane, the former heat insulating wall structure has a problem that the configuration of the furring strip is intricate and the execution of works such as filling urethane is troublesome. Besides, concerning the latter heat insulating wall mounting structure, as the part having difference in a level of the heat insulating material made of hard polyurethane foam or others is fastened to the aeration furring strip the cross section of which is convex, the latter heat insulating wall mounting structure has a problem that the configuration of the furring strip and the heat insulating material is intricate and the execution of works is troublesome.

### SUMMARY OF THE INVENTION

The invention is made in view of such problems and an object is to provide heat insulating wall structure in which the configuration can be simplified without forming a furring strip and others in a special shape, the execution of works is facilitated, a cold (thermal) bridge is prevented and the dew condensation of a framework can be effectively prevented. Besides, the other object is to provide heat insulating wall structure in which when a metal furring strip is used, a cold (thermal) bridge is also prevented and dew condensation can be prevented.

To achieve the objects, the heat insulating wall structure according to the invention is based upon heat insulating wall structure in which a plate is fastened to the outside of a metal framework, a furring strip is fastened to the outside of the plate and an exterior finishing board is fastened to the outside of the furring strip and is characterized in that heat insulating material is inserted between the framework and the plate.

Besides, another embodiment of the heat insulating wall structure according to the invention is based upon heat insulating wall structure in which a plate is fastened to the outside of a metal framework, a furring strip is fastened to the outside of the plate and an exterior finishing board is fastened to the outside of the furring strip and is characterized in that heat insulating material is inserted between the plate corresponding to a position of the framework and the furring strip.

According to the heat insulating wall structure according to the invention configured as described above, in a building provided with the metal framework, a chill from the outside of the building is transmitted to the inside of the building via the metal framework through the exterior finishing board, the furring strip and the plate, however, as the heat insulating material is inserted between the framework and the plate or between the plate and the furring strip, outside air at low temperature for example is interrupted by the heat insulating material, a cold (thermal) bridge is prevented, and the metal framework is prevented from being at a dew point or lower. Therefore, dew condensation on the framework is prevented and the framework can be prevented from being rusted. Internal dew condensation on the inside of the building can be also effectively prevented.

A preferred embodiment of the heat insulating wall structure according to the invention is characterized in that the heat insulating material is provided with parts the bearing strength of which is high. Besides, it is desirable that the heat insulating material is made of thermoplastic resin and includes plural highly foamed parts and lowly foamed parts the bearing strength of which is high and which surrounds the plural highly foamed parts. According to this configuration, as the heat insulating material is provided with a part the bearing strength of which is high such as the lowly foamed parts, the heat insulating material is inserted between the framework and the plate or between the plate corresponding to the position of the framework and the furring strip, is prevented from being crushed when the heat insulating material is fastened by a nail and others, and heat insulating performance can be prevented from being deteriorated.

Further, preferred another embodiment of the heat insulating wall structure according to the invention is characterized in that the heat insulating material is formed by mixing bearing members in a foamed body made of thermoplastic resin. The bearing members are formed by a hardly crushed substance, the foamed heat insulating material is kept at predetermined thickness without being crushed even if the foamed heat insulating material is pressed between the framework and the plate or between the plate and the furring strip by mixing the bearing members so that the bearing members pierces the foamed heat insulating material in a direction of the thickness, and heat insulating performance can be prevented from being deteriorated.

Preferred further another embodiment of the heat insulating wall structure according to the invention is characterized in that the furring strip is made of metal and is provided with a protruding portion opposite to the plate in small area with the heat insulating material between the plate and the furring strip. In the heat insulating wall structure according to the invention configured as described above, as area in which the furring strip and the plate are in contact is small even if the metal furring strip is used, the transmission of a chill is reduced and dew condensation on the metal framework can be prevented.

### BRIEF DESCRIPTION OF THE DRAWINGS

FIG. 1 is a perspective view showing a main part of one embodiment of heat insulating wall structure according to the invention;

FIG. 2 is a sectional view showing the heat insulating wall structure shown in FIG. 1 in a horizontal direction;

FIG. 3A is a sectional view showing a main part of the structure of foamed heat insulating material used in the heat insulating wall structure shown in FIGS. 1 and 2;

FIG. 3B is a bottom view showing the main part;

FIG. 4A is a perspective view showing a main part of another example of the foamed heat insulating material used in the heat insulating wall structure shown in FIGS. 1 and 2;

FIG. 4B is a perspective view showing a main part of further another example of the foamed heat insulating material;

FIG. 5 is a perspective view showing a main part of another embodiment of the heat insulating wall structure according to the invention;

FIG. 6 is a sectional view showing the main part in a horizontal direction of the heat insulating wall structure shown in FIG. 5;

FIG. 7 is a perspective view showing a main part of further another embodiment of the heat insulating wall structure according to the invention;

FIG. 8 is a sectional view showing the main part in a horizontal direction of the heat insulating wall structure shown in FIG. 7; and

FIG. 9 is a perspective view showing a main part of a metal furring strip used in the heat insulating wall structure shown in FIGS. 7 and 8.

### DETAILED DESCRIPTION OF THE PREFERRED EMBODIMENTS

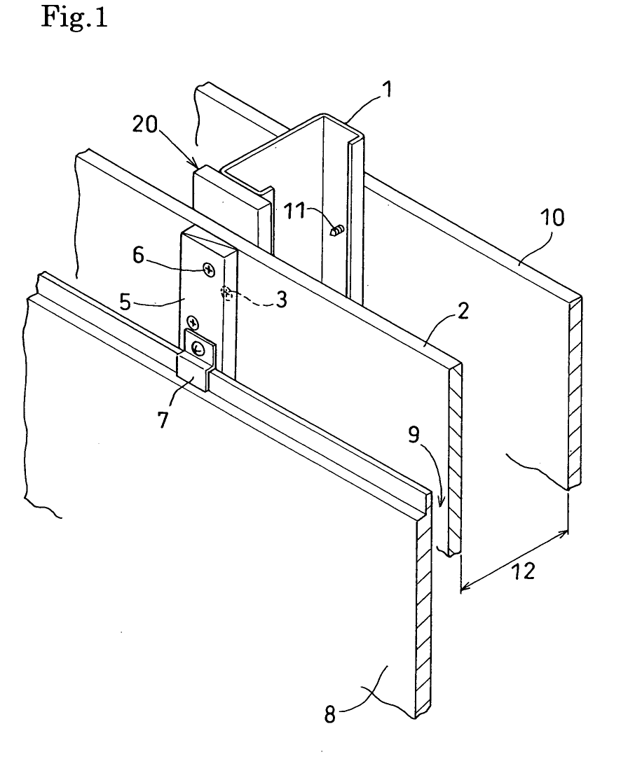

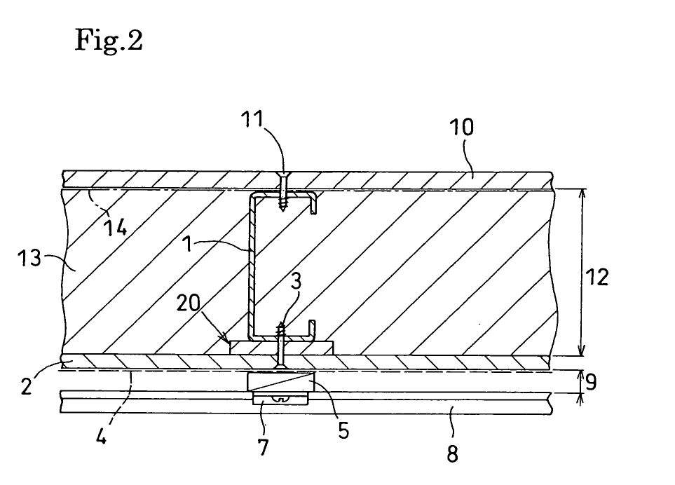

Referring to the drawings, one embodiment of heat insulating wall structure according to the invention will be described in detail below. FIG. 1 is a perspective view showing a main part of the heat insulating wall structure equivalent to this embodiment and FIG. 2 is a sectional view showing the heat insulating wall structure shown in FIG. 1 in a horizontal direction. In FIG. 1, heat insulating material such as glass wool shown in FIG. 2 is omitted.

Concerning the heat insulating wall structure shown in FIGS. 1 and 2, bearing plywood 2 as a plate is fastened to the outside on the outside of a building of a frame 1 made of metal such as steel as a framework by a screw 3 and others with a foamed heat insulating material 20 between the frame and the bearing plywood, and the foamed heat insulating material 20 which is a foamed body is inserted between the frame 1 and the bearing plywood 2. A waterproof sheet 4 is laid outside the bearing plywood 2, a wooden furring strip 5 the cross section of which is rectangular is fixed to the outside of the waterproof sheet 4 by a screw 6 or a nail, and an exterior finishing board 8 such as siding is fastened to the furring strip 5 via a metal fitting 7. Hereby, an aeration layer 9 is formed between the bearing plywood 2 and the exterior finishing board 8. For the frame 1, channel steel the cross section of which is substantially C-frame is shown, however, the invention is not limited to this and for example, square pipe steel, H-steel and L-type steel can be used.

An interior board 10 such as a gypsum board is fastened to the metal frame 1 on the inside of the building by a screw 11 and others, and glass wool 13 as heat insulating material is arranged in heat insulating space 12 between the bearing plywood 2 and the interior board 10. A film 14 is provided to the glass wool 13 on the inside of the building. A cloth sheet or wall paper is bonded to the interior board 10 if necessary.

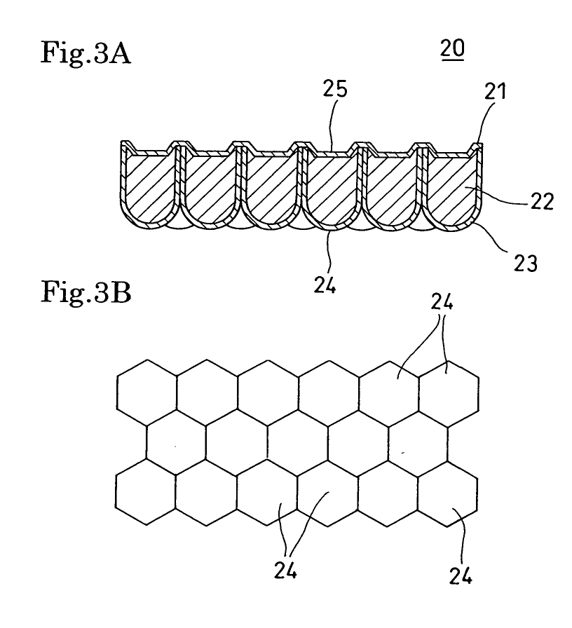

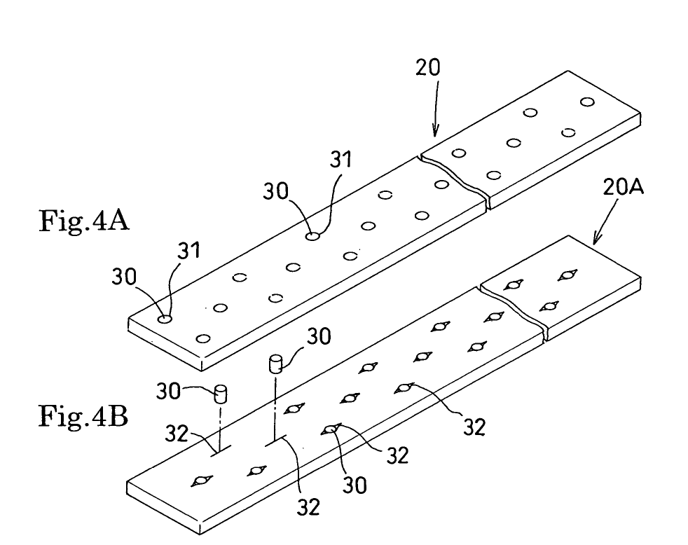

Next, referring to FIGS. 3 and 4, the foamed heat insulating material 20 which is the foamed body will be described in detail. FIG. 3A is a sectional view showing a main part of the structure of the foamed heat insulating material used for the heat insulating wall structure shown in FIGS. 1 and 2, FIG. 3B is a bottom view showing the main part, FIG. 4A is a perspective view showing a main part of another example of the foamed heat insulating material used for the heat insulating wall structure shown in FIGS. 1 and 2, and FIG. 4B is a perspective view showing a main part of further another example.

The foamed heat insulating material 20 shown in FIG. 3 is a board having the thickness of approximately 10 mm and provided with a continuous foamed layer 21 made of thermoplastic resin, highly foamed parts 22 made of thermoplastic resin and arranged at least on one side of the continuous foamed layer 21 in plurality and lowly foamed thin parts 23 that covers the outer surface of the highly foamed parts 22 together with the continuous foamed layer 21.

To explain the configuration of the foamed heat insulating material 20 further in detail, the lowly foamed thin parts 23 exist in a direction of the thickness of the board, one surface of the board are made convexes 24, and the other surface are made concaves 25. The convex parts and the concave parts form a honeycomb type in which equilateral hexagons range when they are viewed from the top and from the bottom. The lowly foamed thin parts 23 are a part in which bearing strength is large.

Thermoplastic resin used for the continuous foamed layer 21, the highly foamed parts 22 and the lowly foamed thin parts 23 is not particularly limited, however, polyolefin resin such as polyethylene and polypropylene or the mixture of these is desirable, and high-density polyethylene that can realize high compressive strength, homopolypropylene or the mixture of these is particularly desirable.

Thermoplastic resin used for the continuous foamed layer 21, the highly foamed parts 22 and the lowly foamed thin parts 23 is not required to be identical, however, as the fusion strength of each part is high when the same type of resin is used and the rupture is hardly caused when a compressive load is applied, it is desirable that the same type of resin is used. The expansion ratio of the continuous foamed layer 21 is 1.1 to 10 times, desirably 2 to 8 times, preferably 2 to 7 times, and the thickness is 100 μm to 5 mm, desirably 300 μm to 3 mm and preferably 500 μm to 2 mm.

The expansion ratio of the highly foamed parts 22 is 2 to 100 times, desirably 5 to 50 times, preferably 10 to 35 times, for the size, 3 to 50 mm is desirable and 5 to 30 mm is preferable. The size of the highly foamed parts 22 means the maximum value of the size in a direction of the cross section. The expansion ratio of the lowly foamed thin parts 23 is 1.1 to 10 times, desirably 1.2 to 7 times, preferably 1.2 to 5 times, and the thickness is 30 to 500 μm, desirably 40 to 400 μm and preferably 50 to 400 μm.

Heat insulating materials shown in FIG. 4 are formed by mixing bearing members 30 made of material the heat conductivity of which is small such as plastic and rubber as a part strong in pressure applied to the foamed heat insulating material 20 made of thermoplastic resin, and the bearing members 30 are arranged at random or regularly. The bearing members 30 are cylindrical, pierces the foamed heat insulating material 20 in a direction of the thickness, and keeps fixed thickness to prevent the thickness of the foamed heat insulating material 20 from decreasing when the plane of another plate comes in contact with both planes in the direction of the thickness and the foamed heat insulating material is pressed.

The bearing members 30 are inserted into a through hole 31 formed in the foamed heat insulating material 20 as shown in FIG. 4A and can be supported by the board. As the foamed heat insulating material 20 can be connected with predetermined thickness without collapsing owing to the bearing members 30 when the frame 1 and the bearing plywood 2 are fastened by the screw 3, heat insulating performance is never deteriorated. In a foamed heat insulating material 20A shown in FIG. 4B, a slit 32 is formed and supports bearing members 30. The bearing members 30 are not limited to a cylinder, may be also prismatic and spherical and the form is not particularly limited. The board of the foamed heat insulating material 20 may also have the structure shown in FIG. 3.

Concerning the heat insulating wall structure equivalent to this embodiment configured as described above, in a cold district for example, the inside of a building is kept at warm temperature even if the outside of the building is at low temperature, after moisture on the inside of the building gradually gets into the aeration layer 9 through the interior board 10 such as a gypsum board and the glass wool 13, the moisture is sent out upward in the aeration layer 9 communicating with the outside of the building and is exhausted outside the building from the upside of the building.

In this case, a chill (low temperature) on the outside of the building is transmitted to the metal frame 1 the heat conductivity of which is large and which satisfactorily transmits heat from the fastening screw 3 via the exterior finishing board 8 and the furring strip 5 and reaches the inside, however, as the head of the fastening screw 3 is covered with the furring strip 5 and the foamed heat insulating material 20 is inserted between the bearing plywood 2 and the frame 1, the transmission of the chill is interrupted, a cold (thermal) bridge is prevented, and the frame 1 is prevented from being at a dew point or lower. Therefore, no dew is formed on the frame 1, the frame can be prevented from being rusted, and dew condensation on the inside can be prevented.

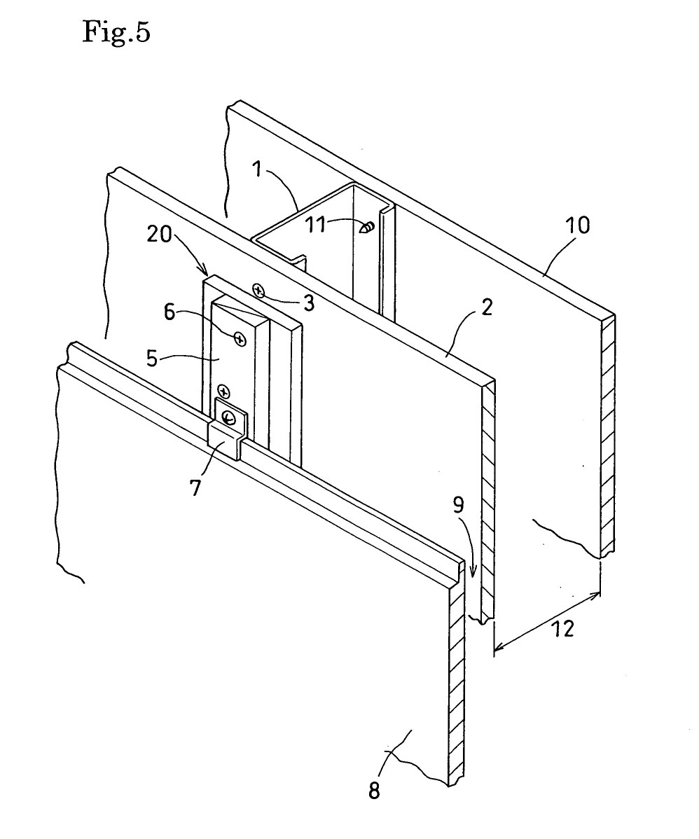

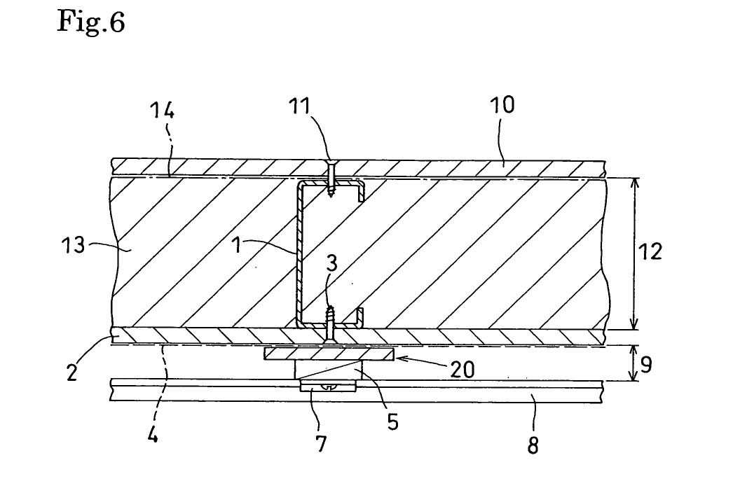

Next, referring to FIGS. 5 and 6, another embodiment of the invention will be described in detail. FIG. 5 is a perspective view showing a main part of another embodiment of the heat insulating wall structure according to the invention, and FIG. 6 is a sectional view showing the main part of FIG. 5 in a horizontal direction. This embodiment is characterized differently from the above-mentioned embodiment in that a foamed heat insulating material 20 is inserted between bearing plywood 2 corresponding to the position of a framework and a furring strip 5 and a partial external insulating type is adopted. The same reference number is allocated to the other substantially similar configuration and the detailed description is omitted.

As shown in FIGS. 5 and 6, the wooden furring strip 5 is fixed to the outside of the plywood 2 by screws 6 and others via the foamed heat insulating material 20 outside a waterproof sheet 4. Wall structure according to a partial external insulating type in which an exterior finishing board 8 is fixed to the outside of the furring strip 5 via a metal fitting 7 as in the above-mentioned embodiment and an aeration layer 9 is formed between the exterior finishing board 8 and the bearing plywood 2 is acquired. The foamed heat insulating material 20 is made of polyethylene resin and others as in the above-mentioned embodiment and bearing members 30 are inserted at a predetermined interval.

In this embodiment, a chill (low temperature) on the outside of a building reaches the exterior finishing board 8 and the furring strip 5, however, the chill is hardly transmitted from the furring strip 5 to the bearing plywood 2 owing to the foamed heat insulating material 20 between the furring strip 5 and the bearing plywood 2. Therefore, the frame 1 is prevented from being at a dew point or lower, dew condensation on the frame 1 is prevented, the frame can be prevented from being rusted, and dew condensation on the inside of the building can be prevented. When the furring strip 5 is fastened, it is fastened by screws 6 via the foamed heat insulating material 20, however, the foamed heat insulating material 20 is prevented by the bearing members 30 from being crushed and can be kept at fixed thickness. Therefore, fastening is facilitated and heat insulating performance is never deteriorated.

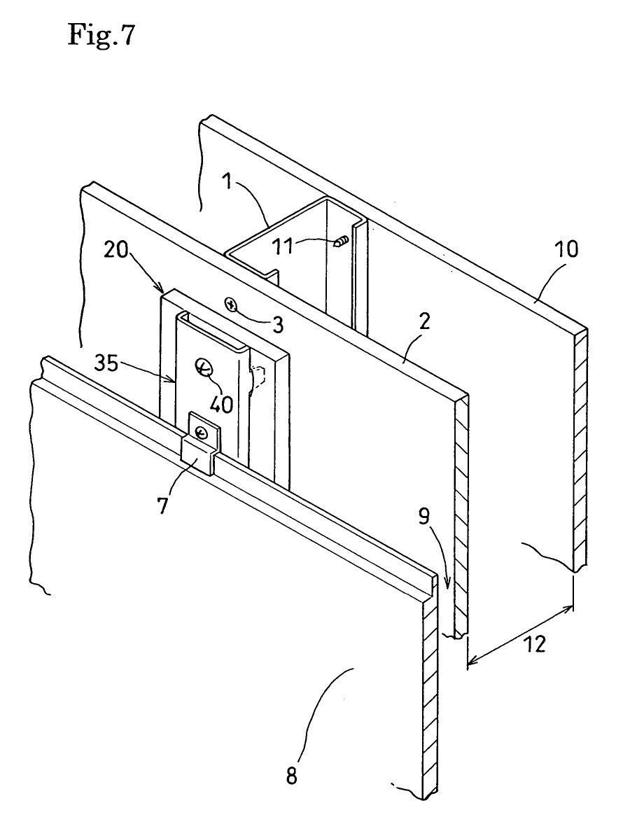

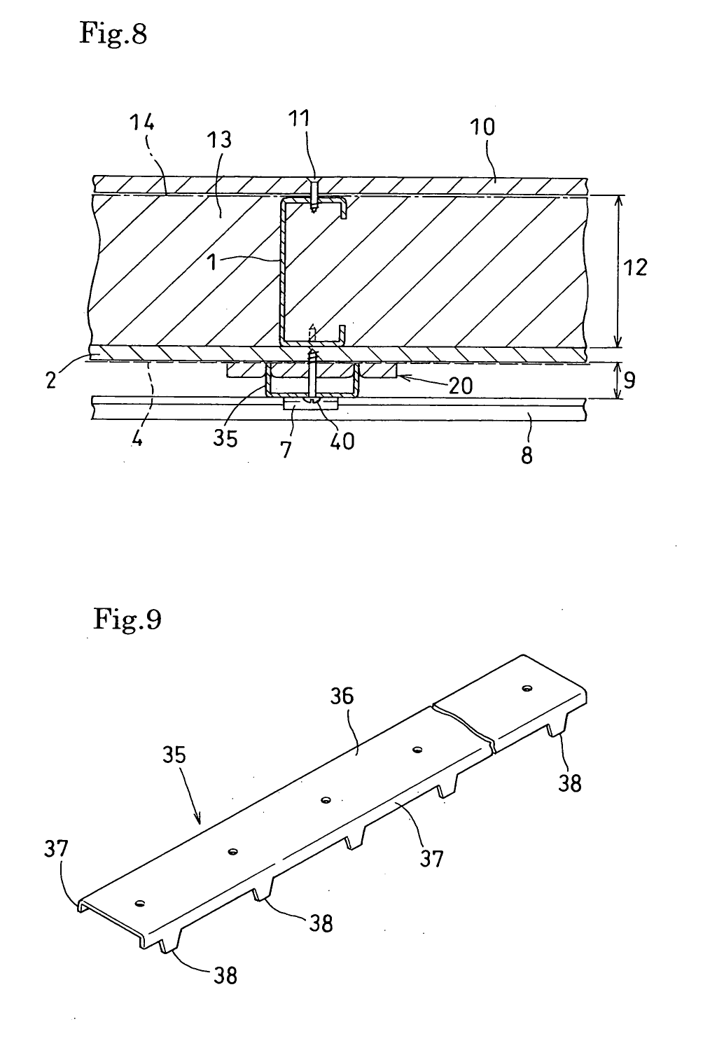

Further, referring to FIGS. 7 to 9, another embodiment of the invention will be described in detail below. FIG. 7 is a perspective view showing a main part of further another embodiment of the heat insulating wall structure according to the invention, FIG. 8 is a sectional view showing the main part in a horizontal direction, and FIG. 9 is a perspective view showing a main part of a metal furring strip shown in FIGS. 7 and 8. This embodiment is characterized differently from the second embodiment in that the furring strip is made of metal, is opposite to bearing plywood in a spot and the area of the opposite part is small. The same reference number is allocated to the other substantially similar configuration and the detailed description is omitted.

As shown in FIGS. 7 to 9, concerning the metal furring strip 35, legs 37, 37 are extended at a right angle from both sides of the head 36 for fastening the exterior finishing board 8, the cross section is substantially C-frame, and protruding portions 38 are protruded from the legs 37 at a predetermined interval. The metal furring strip 5 is fixed to the bearing plywood 2 from the outside of the foamed heat insulating material 20 by a fixing screws 40, the protruding portions 38 are in contact with the bearing plywood 2 with the foamed heat insulating material 20 between the furring strip and the bearing plywood, the width of the protruding portions at the lower end is reduced so that the protruding portions are opposite to the bearing plywood 2 in small area, and the protruding portions are inclined so that the width gradually increases toward the head. The exterior finishing board 8 is fixed to the metal furring strip 35 by screwing a metal fitting 7.

In this embodiment, the protruding portions 38 of the metal furring strip 35 pierces the foamed heat insulating material 20, are touched to the bearing plywood 2 and are in a state buried in the foamed heat insulating material 20. Therefore, heat is hardly transmitted from the protruding portions 38 to the bearing plywood 2, a cold (thermal) bridge is prevented, and the metal frame 1 can be prevented from being at a dew point or lower. The frame 1 can be prevented from being rusted by dew condensation, dew condensation inside a building can be also prevented and comfortability can be enhanced.

The embodiments of the invention have been described in detail above, however, the invention is not limited to the embodiments, and various design changes are possible unless they deviate from the concept of the invention disclosed in the claims. For example, the furring strip is not only wooden or metallic but may be also made of resin. The glass wool is used for heat insulating material located between bearing plywood and the interior board; however, it is natural that another heat insulating material such as rock wool may be also used. Further, the invention is not limited to the foamed heat insulating material for heat insulating material.

As understandable from the above description, as in the heat insulating wall structure according to the invention, the configuration is simple, the execution of works is easy, a cold (thermal) bridge is prevented by the foamed heat insulating material, the metal framework is prevented from being at a dew point or lower and dew condensation is prevented, the emergence of rust can be inhibited. Dew condensation on the inside of the building can be prevented.

What is claimed is:

1. Heat insulating wall structure in which a plate is fastened to the outside of a metal framework, a furring strip is fastened to the outside of the plate and an exterior finishing board is fastened to the outside of the furring strip, wherein:
heat insulating material is inserted between the framework and the plate.

2. Heat insulating wall structure in which a plate is fastened to the outside of a metal framework, a furring strip is fastened to the outside of the plate and an exterior finishing board is fastened to the outside of the furring strip, wherein:
heat insulating material is inserted between the plate corresponding to the position of the framework and the furring strip.

3. Heat insulating wall structure according to claim 1 or 2, wherein:
the heat insulating material is provided with parts having large bearing strength.

4. Heat insulating wall structure according to claim 3, wherein:
the heat insulating material is made of thermoplastic resin; and
the heat insulating material includes plural highly foamed parts and lowly foamed parts the bearing strength of which is high and which is arranged so that the lowly foamed parts surrounds the highly foamed parts.

5. Heat insulating wall structure according to claim 1 or 2, wherein:
the heat insulating material is formed by mixing bearing members in a foamed body made of thermoplastic resin.

6. Heat insulating wall structure according to claim 2, wherein:
the furring strip is formed by metal; and
the furring strip is provided with protruding portions opposite to the plate in small area with the heat insulating material between the furring strip and the plate.
